(19) United States
(12) Patent Application Publication
(10) Pub. No.: US 2006/0135339 A1
(43) Pub. Date: Jun. 22, 2006

(54) Rotation body arrangement

(76) Inventor: Martin Sandgren, Nacka (SE)

Correspondence Address: YOUNG & THOMPSON, 745 SOUTH 23RD STREET, 2ND FLOOR, ARLINGTON, VA, 22202, US

(21) Appl. No.: 10/518,518

(22) PCT Filed: Jun. 19, 2003
(86) PCT No.: PCT/SE03/01048

§ 371 Date: Jul. 22, 2005

(30) Foreign Application Priority Data
Jun. 19, 2002 (SE) 0201883-6

(51) Int. Cl. B04B 7/12

(52) U.S. Cl. 494/68

(57) ABSTRACT

The invention relates to an arrangement comprising a rotational body rotatable about a longitudinal centre axis and composed of a plurality of identical adjacent elements (10). The elements are fixed relative to each other in the circumferential direction and are separated axially. For balancing of the rotational body, the elements (10) each have, on one side, an axially directed projection (14) and, on its reverse side, a notch (16), which is angularly displaced a certain amount from the projection (14) in the circumferential direction of the element.

### TECHNICAL FIELD

The present invention relates to an arrangement of a rotational body and in particular to an arrangement comprising a rotational body rotatable about a longitudinal centre axis and composed of a plurality of adjacent elements, where said adjacent elements are circumferentially fixed and axially separated. Examples of such a rotor are a fan, a pump, a centrifugal separator, a turbine or the like.

### BACKGROUND OF THE INVENTION

When assembling rotors, e.g. centrifugal separators, normally many identical disc-shaped separation elements are stacked with a small distance between them. The discs, which are substantially rotationally symmetrical and can be of metal or plastics material, usually have inherent small manufacturing tolerance defects, which can cause imbalance to occur in the assembled rotational body. It is essential, for example, for reliable functioning that the rotational body composed of the elements is in precise balance both statically and dynamically. To achieve such good balance, a very narrow manufacturing tolerance is required for each individual element, which is expensive. Alternatively, after-balancing is required of such a rotational body, which is both time-consuming and expensive.

### PURPOSE AND SOLUTION OF THE INVENTION

A primary purpose of the present invention is to achieve an arrangement of the type described by way of introduction, in which the need is removed for after-balancing of the rotor due to the manufacturing tolerances of the individual elements.

For this purpose the arrangement according to the invention is characterized in that each of the elements has, on one side, an axially directed projection and, on its reverse side, a notch, which is angularly displaced a certain amount from the projection in the circumferential direction of the element, the projection of each element engaging in the notch of an adjacent element, so that the projections on adjacent elements will be successively displaced in the same circumferential direction with a spacing corresponding to the angular displacement between the projection and the notch in each element. By virtue of the fact that each element when assembled must be rotated a certain angle corresponding to the angle between the projection and the notch of the element, and necessarily in only one circumferential direction, any off-centre deviation of the centre gravity from the centre in the individual elements, caused by constant tolerance error in manufacturing, will be distributed evenly about the rotational body in its circumferential direction. If there is a constant imbalance of the individual discs, it will be evened out against each other and make the entire rotational body balanced.

Additional features of the arrangement according to the invention will be evident in more detail below with reference to the accompanying drawings.

### SHORT DESCRIPTION OF THE DRAWINGS

FIG. 1 is a plan view of a group of disc elements in a rotational body according to the invention;

FIG. 2 is a cross-sectional view taken along the line A-A in FIG. 1; and

FIG. 3 is a schematic exploded view in perspective of a set of disc elements arranged in accordance with the present invention.

### DETAILED DESCRIPTION OF THE INVENTION

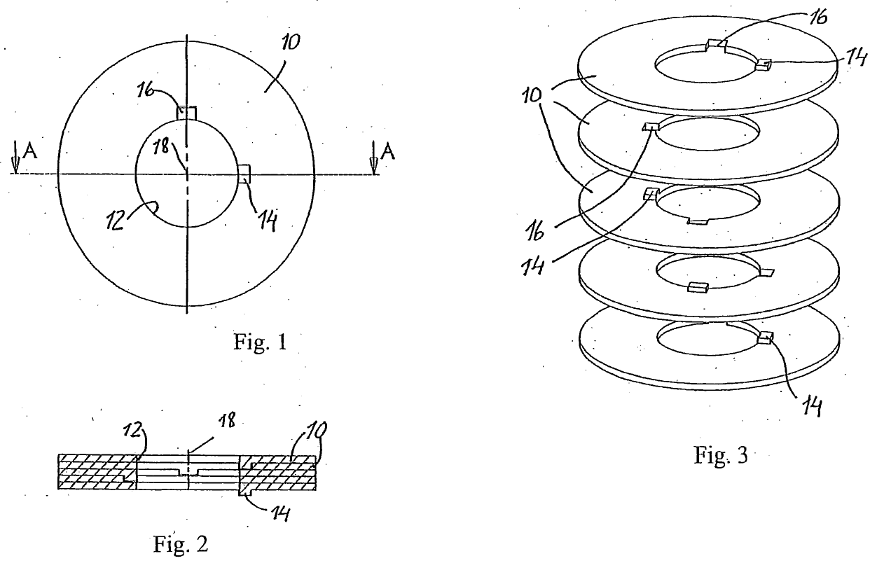

FIG. 1 shows in schematic form a flat, circular disc element 10 of a rotational body for a centrifugal separator. The disc element 10 can also have another shape, e.g. a conic configuration. Each disc element 10 is provided with a circular centre hole 12. Furthermore, each disc element 10 has a spacer element (not shown) which is intended to maintain a small predetermined axial spacing between disc elements 10 stacked on top of each other in the rotational body (not shown). The disc elements are preferably made of a light plastics material having a projection 14 near the periphery of the centre hole 12 and a notch 16, which is angularly displaced 90° from the projection 14 and is also located along the periphery of the centre hole 12, at the same radial distance from the centre of the disc element 10 as the projection 14. The projection 14 has a shape which securely fits into the notch 16. Even if the notch 16 is shown as a notch which extends through the entire thickness of the disc 10, it is possible that the notch 16 should be made as a non-through hole on the side of the disc element 10 opposite the projection.

By virtue of the fact that the disc elements 10 are made with said angularly spaced projections 14 and corresponding notches 16, it will become necessary, when stacking the disc elements 10, to rotate each successive disc element 90° relative to the preceding disc element, so that the projection 14 on the disc element being applied will engage the notch 16 of the preceding element, as can be seen in FIGS. 2 and 3, or vice versa, i.e. that a notch will come into engagement with a corresponding projection. Any imbalance in the individual disc element 10 will thus be evenly distributed circumferentially about the longitudinal centre axis 18 after completed assembly of the four disc elements 10, or a multiple thereof, i.e. 8, 12, 16, 20, 24, etc.

Despite the fact that the projection 14 and the notch 16 in the example shown are angularly displaced 90° on the disc element 10, it is of course possible, within the scope of the invention, to select another angle within the range of 0-360°. The number of disc elements 10 in a composite rotational body can be selected with advantage so that this number multiplied by the angle between the projection and the notch is 360° or a multiple of 360° to balance out the rotational body, should the centre gravity be displaced from the centre of the individual disc elements, caused by a constant tolerance error when manufacturing the identical disc elements 10.

The projection 14 and the notch 16 (the hole) in the disc elements 10 can be placed at other locations on the disc element than at the inner periphery of the centre hole 12. Likewise, the compatible shape of the individual projections and notches can be varied in many ways.

Even though the above detailed description is related to an example where the disc elements form a rotational body for a centrifugal separator, the invention is, of course, not limited to this application but can in general be used in rotors composed of a number of identical components.

1. Arrangement comprising a rotational body rotatable about a longitudinal centre axis and composed of a plurality of adjacent elements (10), where said elements are circumferentially fixed and axially separated, characterized in that each of the elements (10) has, on one side, an axially directed projection (14) and, on its reverse side, a notch (16), which is angularly displaced a certain amount from the projection in the circumferential direction of the element, the projection (14) of each element engaging in the notch (16) of an adjacent element, so that the projections on adjacent elements will be successively displaced in the same circumferential direction with a spacing corresponding to the angular displacement between the projection (14) and the notch (16) in each element (10).

2. Arrangement according to claim 1, characterized in that the projection (14) and the notch (16) on each of the elements (10) are located at the same radial distance from the centre (18) of the element.

3. Arrangement according to claim 1, characterized in that the notch (16) in each element (10) extends through the entire thickness of the element.

4. Arrangement according to claim 1, characterized in that the number of elements (10) in the rotational body is such that this number multiplied by the angle between the projection and the notch in each element is 360° or a multiple of 360°.

5. Arrangement according to claim 1, characterized in that the projection (14) and the notch (16) in each element (10) are disposed so that they abut the periphery of the inner centre opening (12) of the element (10).

6. Arrangement according to claim 1, characterized in that the elements (10) are disc elements for a centrifugal separator.

7. Arrangement according to claim 2, characterized in that the notch (16) in each element (10) extends through the entire thickness of the element.

8. Arrangement according to claim 2, characterized in that the number of elements (10) in the rotational body is such that this number multiplied by the angle between the projection and the notch in each element is 360° or a multiple of 360°.

9. Arrangement according to claim 3, characterized in that the number of elements (10) in the rotational body is such that this number multiplied by the angle between the projection and the notch in each element is 360° or a multiple of 360°.

10. Arrangement according to claim 2, characterized in that the projection (14) and the notch (16) in each element (10) are disposed so that they abut the periphery of the inner centre opening (12) of the element (10).

11. Arrangement according to claim 3, characterized in that the projection (14) and the notch (16) in each element (10) are disposed so that they abut the periphery of the inner centre opening (12) of the element (10).

12. Arrangement according to claim 4, characterized in that the projection (14) and the notch (16) in each element (10) are disposed so that they abut the periphery of the inner centre opening (12) of the element (10).

13. Arrangement according to claim 2, characterized in that the elements (10) are disc elements for a centrifugal separator.

14. Arrangement according to claim 3, characterized in that the elements (10) are disc elements for a centrifugal separator.

15. Arrangement according to claim 4, characterized in that the elements (10) are disc elements for a centrifugal separator.

16. Arrangement according to claim 5, characterized in that the elements (10) are disc elements for a centrifugal separator.
